(19) United States
(12) Patent Application Publication
(10) Pub. No.: US 2008/0225830 A1
(43) Pub. Date: Sep. 18, 2008

(54) CIRCUIT WITH GENERATING PHONE-CALL RING VIA COMPUTER SYSTEM AND INTERNET PHONE SYSTEM USING THE CIRCUIT

(75) Inventor: Rong-Hwa Ding, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SOLID STATE SYSTEM CO., LTD., Hsinchu (TW)

(21) Appl. No.: 11/684,643

(22) Filed: Mar. 12, 2007

(51) Int. Cl. H04L 12/66

(52) U.S. Cl. 370/352

(57) ABSTRACT

An internet phone system is implemented in a computer system, including an internet-phone software unit, for storing a software used by the computer system to operate as an internet phone. An audio-file storage software unit is for storing a plurality of audio files. A USB (Universal Serial Bus) audio interface software unit is coupled with the internet-phone software unit and the audio-file storage unit. A USB audio apparatus is coupled to the audio interface unit, and comprising at least a microphone and a speaker. Wherein, the USB audio interface unit stores a software for selecting one of the audio files to serve as the phone-call ring, and for driving the speaker in the USB audio apparatus by the computer system for generating ringing sound for an incoming call.

### BACKGROUND OF THE INVENTION

1. Field of Invention

The present invention relates to internet phone. More particularly, the present invention relates to a phone-call ring circuit implemented in the internet phone system to generate a phone-call ring in a desired type.

2. Description of Related Art

Internet has been well developed and widely applied to the computer system. In other words, nowadays, a voice of internet phone (VOIP) can be implemented in a computer system for communicating with a remote VOIP via internet. The internet phone has been very popular. A user can use the microphone and the speaker of the computer system, or even the earphone set, to achieve the function of telephone as usual. The USB (Universal Serial Bus) protocol for transmitting data can be used to efficiently transmit the communication information.

However, the conventional phone-call ring in the audio apparatus to inform the user is in very simple tone without active option. FIG. 1 is a diagram, schematically illustrating a conventional internet phone system. In FIG. 1, the computer system 100 includes a host 102. Usually, the host 102 has the USB port for transmitting data based on the USB protocol. A USB internet phone 104 can be connected to the host 102 to make the connection to the internet. The conventional internet phone can have a controller, such as a CM109 USB I/O controller, to control the data transmission. Further, a USB earphone set 106 can be also connected to the host 102. For this kind of internet phone, the phone call ring in hardware manner generated at the USB internet phone 104 with a buzzer, or the earphone set 106 is rather simple without choice by a user. Since the ringing through the earphone set is too weak in volume level to be heard, the type of ring cannot actively indicate a phone-call is coming.

FIG. 2 is a diagram schematically illustrating another conventional internet phone system. In FIG. 2, the computer system includes a pair of speakers 204 210 and a microphone 206. The user 208 can speak to the microphone 206 and receive incoming audio by the speaker 204 of the computer system. In this manner, the speaker broadcast the voice in open space. Therefore, a portion of the voice may again enter the microphone 206, causing echo. This kind of arrangement has poor audio quality. In addition, the phone-call ring is generated by the VOIP software, also simple without choice by the user.

In at least considering the foregoing issues, manufacturers still looks for other solutions to improve the audio communication.

### SUMMARY OF THE INVENTION

The invention provides a circuit with generating a phone-call ring of internet phone in the computer system with various choices by the user.

The invention provides a circuit with generating a phone-call ring via a computer system, which can be connected to an internet. The circuit includes an internet-phone software unit, for storing a software used by the computer system to operate as an internet phone. An audio file storage unit stores a plurality of audio files. An audio interface unit is coupled with the internet-phone software unit and the audio-file storage unit. Wherein, the audio interface unit stores a software for selecting one of the audio files to serve as the phone-call ring, and for driving an external USB connection audio apparatus by the computer system for audio communication.

The invention also provides an internet phone system, implemented in a computer system, comprises an internet-phone software unit, for storing a software used by the computer system to operate as an internet phone. An audio-file storage unit is for storing a plurality of audio files. An audio USB interface unit is coupled with the internet-phone software unit and the audio-file storage unit. A USB audio apparatus is coupled to the audio interface unit, and comprises at least a microphone and a speaker. Wherein, the audio interface unit stores a software for selecting one of the audio files to serve as the phone-call ring, and for driving the speaker in the audio apparatus by the computer system for this phone call ring. After the user pick up the phone, user can use the earphone or speaker for audio communication.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram, schematically illustrating a conventional internet phone system.

FIG. 2 is a diagram, schematically illustrating another conventional internet phone system.

FIG. 3 is a diagram, schematically illustrating an internet phone system, according to an embodiment of the invention.

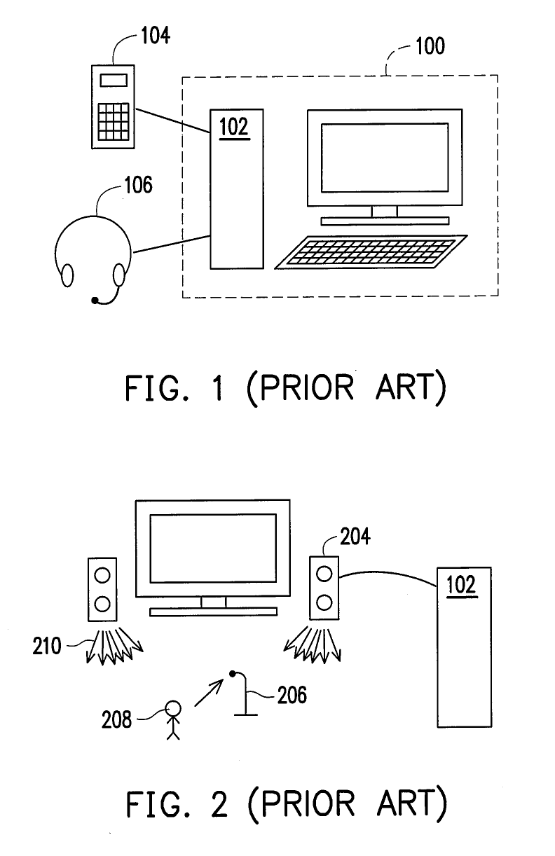

### DESCRIPTION OF THE PREFERRED EMBODIMENTS

In the invention, a circuit with generating a phone-call ring via a computer system is provided. The circuit can be implemented in the computer system in uses for the internet phone. Even further, the circuit can be implemented in a mobile device as a mobile VOIP application. The present invention can allow the phone-call ring to be in various forms for free choice from user. Several embodiments are provided for descriptions but the invention is not limited to the embodiments.

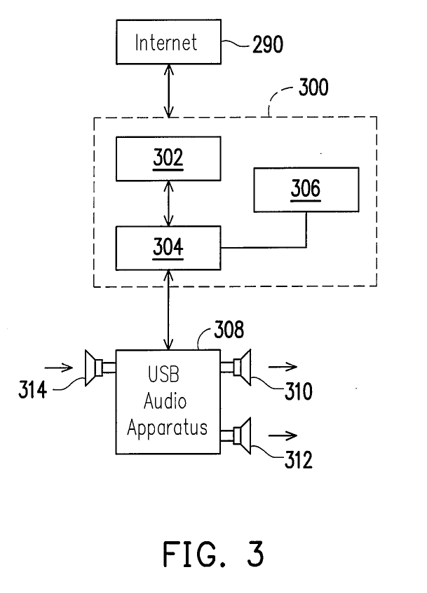

FIG. 3 is a diagram, schematically illustrating an internet phone system, according to an embodiment of the invention. In FIG. 3, the circuit 300 with generating a phone-call ring is, for example, implemented in a computer system and can be connected to the Internet 290 for communication. For the internet phone, the circuit 300 can also connected with an audio apparatus 308. The audio apparatus 308 is, for example, a USB audio apparatus. The USB audio apparatus can have, for example, a microphone 314 to receive an audio input, a speaker 310 to broadcast the audio signal from the circuit 300, and further i.e. an earphone driver 312 used in earphone set. The audio apparatus 308 is also driven by the circuit 300 to generate a desired type of phone-call ring from the circuit. In other words, the audio apparatus 308 is not necessary to generate a fixed type of phone-call ring, made by hardware manner. In order to have this function, the circuit 300 needs some function units.

The circuit 300 basically includes an internet-phone software unit 302, such as a voice of internet phone (VOIP), which is used in connection to the internet 290 for setting the communication up. An audio-file storage unit 306 is used for storing a plurality of audio files. The audio files include, for example, voice files or music files, which can be selected to serve as the phone-call ring later.

An audio interface unit 304 is coupled with the internet-phone software unit 302 and the audio-file storage unit 306. Wherein, the audio interface unit 304 includes a software for selecting one of the audio files in the audio-file storage unit 306 to serve as the phone-call ring. The audio interface unit 304 also includes the software for driving the external-connection audio apparatus 308 by the computer system 300 for audio communication. The USB protocol is a popular manner in transmitting data. In other words, the communication between the audio interface unit 304 and the audio apparatus 308 in the present invention is based on USB protocol.

The audio interface unit 304 and the audio file storage unit 306 can be implemented as one single application software. This example is used for explanation purpose.

Basically, the audio interface unit 304 can provide audio signal to the audio apparatus 308 to play. During the period without phone-call, the audio apparatus 308 can broadcast desired music or voice as user's option. However, when a phone call is detected, then the selected phone-call ring from the audio interface unit 304 is broadcasted from the speaker 310 for high volume level. The high volume level is essential in comparison with the earphone set, so as to have high efficiency to inform people to receive the call. However, the earphone set may also broadcast the phone-call ring if it is necessary. After the phone call is received, the audio apparatus 308 serve as a telephone and the speaker 310 or earphone driver 312 can be used for telephone voice playback in at least audio communication or even with the image communication as a video communication.

In the foregoing circuit, the internet-phone software unit 302, the audio interface unit 304, and the audio-file storage unit 306 are for example arranged in a mobile device, such as a RTOS (real time operating system, for example, Linux or Symbian) running on a CPU chip. In other words, for an internet phone system, it can include the internet-phone software unit 302, the audio-file storage unit 304, the audio interface unit 306, and the USB audio apparatus 308. Wherein, the audio interface unit also allows for selecting one of the audio files to serve as the phone-call ring, and for driving the audio apparatus by the RTOS system for audio communication.

Based on the function of the internet-phone software unit 302, the audio-file storage unit 304, the audio interface unit 304, and the audio apparatus 308. The driving software program can be written as, for example, a firmware, which are properly stored in the related units. The person with ordinary skill can know how to design the internet phone with the foregoing features.

The present invention proposes the audio-file storage unit 304 and the audio interface unit 306 to generate a desired phone-call ring as selected by the user in free choice. The invention allows the USB audio apparatus 308 to have the phone-call ring with various choices. Even further, different ring can represent different status. All of these are just the applications of the invention as the examples.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An internet phone system, implemented in a computer system, comprising:
an internet-phone software unit, for storing a software used by the computer system to operate as an internet phone;
an audio-file storage software unit, for storing a plurality of audio files;
a USB (Universal Serial Bus) audio interface software unit, coupled with the internet-phone software unit and the audio-file storage unit; and
a USB audio apparatus, coupled to the audio interface unit, and comprising at least a microphone and a speaker,
wherein the USB audio interface unit stores a software for selecting one of the audio files to serve as the phone-call ring, and for driving the speaker in the USB audio apparatus by the computer system for generating ringing sound for an incoming call.

2. The internet phone system of claim 1, wherein the audio files including music files or voice files.

3. The internet phone system of claim 1, wherein the selected one of the audio files can be pre-set by a user via the audio interface unit.

4. The internet phone system of claim 1, wherein the audio USB interface unit communicates with the internet-phone software unit for bi-directionally transmitting a communication voice.

5. The internet phone system of claim 1, wherein the audio interface unit, according to a requirement, outputs either the phone-call ring or a playing audio signal to the external-connection audio apparatus.

6. The internet phone system of claim 1, wherein the audio-file storage software unit and the USB audio interface software unit are stored in an external USB disk device, wherein the corresponding software can be started after the external USB disk device is plugged into the computer system.

7. The internet phone system of claim 1, wherein the internet-phone software unit, the audio-file storage software unit, and the USB audio interface software unit are stored in an external USB disk device; wherein the corresponding software can be started after the USB disk device is plugged into the computer system.

8. An internet phone system, implemented in a computer system, comprising:
an internet-phone software unit, for storing a software used by the computer system to operate as an internet phone;
an audio-file storage software unit, for storing a plurality of audio files;
a USB (Universal Serial Bus) audio interface software unit, coupled with the internet-phone software unit and the audio-file storage unit;
a USB audio apparatus, coupled to the audio interface unit, and comprising at least a microphone and a speaker,
wherein the USB audio interface unit stores a software for selecting one of the audio files to serve as the phone-call ring, and for driving the speaker in the USB audio apparatus by the computer system for generating ringing sound for an incoming call,
wherein the USB audio apparatus further comprises an earphone unit, and when a user picks up a phone call, the audio interface unit switches an output telephone voice to the earphone unit for telephone communication.

9. The internet phone system of claim 8, wherein the speaker of the USB audio apparatus has a sufficient volume level larger than earphone set to inform a distant person to receive the incoming call.
